(19) United States
(12) Patent Application Publication
(10) Pub. No.: US 2005/0180138 A1
(43) Pub. Date: Aug. 18, 2005

(54) Light clip and binder light

(76) Inventor: Jacqueline Marie Steady, Cape May, NJ (US)

Correspondence Address: Jacqueline M. Steady, 1021 CAPE MAY AVENUE, CAPE MAY, NJ, 08204, US

(21) Appl. No.: 10/782,101

(22) Filed: Feb. 18, 2004

(51) Int. Cl. F21V 33/00

(52) U.S. Cl. 362/253

(57) ABSTRACT

A light clip having a top surface including a transparent material, at least one side surface including transparent material and a clip located opposite the top surface. A lighting circuit is included in the light clip, preferably having at least one lamp. Alternatively, a base unit for insertion in a binder including at least a top surface having transparent material and a lighting circuit included in said base unit is provided. This lighting circuit also preferably includes at least one lamp. Rotatable lights may be used in either the light clip or the binder light. Additionally, variously shaped clips may be used for the light clip.

### BACKGROUND OF THE INVENTION

In the field of light clips, few lighting devices are designed to accompany makeup and the containers in which they are held. Some compacts have lighting sources as part of the compact. These compacts, however, fail to include makeup as part of their contents. In addition, binders typically do not include light sources.

### SUMMARY OF THE INVENTION

In many areas, it is necessary to include a light clip. The present invention provides a light that irradiates an area of a makeup compact or a surrounding area in a clipped position. For instance, a square makeup compact or holder typically does not include a light. The present invention is designed to provide a light clip that is releasably secure to an edge region of a makeup holder or a edge region of a partition, for examples.

Another advantage of the present invention is that a light clip is provided that includes a unit having a top surface including transparent material and at least one side surface including transparent material.

Another advantage of the present invention is to provide a clip having at least one base clip member rotatably secured to a bottom region of a unit of said light clip.

Yet another advantage of the present invention is that a light clip is provided that includes plural surfaces having at least one transparent region extending across an entire length of the unit of the light clip.

Another advantage of the present invention provides at least one lamp as a light source.

Another advantage of the present invention includes an interior lining of said light clip permitting increased reflection of light outward from at least one light source.

Alternatively, the present invention is designed to include a lighting device for receipt in a binder.

Another advantage of the present invention includes a top surface having an inner side including a material increasing reflection.

Another advantage of the present invention includes a rotatable light source.

### BRIEF DESCRIPTION OF THE DRAWINGS

FIG. 1 shows a light clip according to a first embodiment of the invention;

FIG. 2 shows a side of a light clip according to the first embodiment of the invention;

FIG. 3 shows a side of a light clip according to the first embodiment of the invention;

FIG. 4 shows a lighting circuit including elements according to the first embodiment of the invention;

FIG. 5 shows a top view of a light clip according to the first embodiment of the invention;

FIG. 6 shows a back view of a light clip according to the first embodiment of the invention;

FIG. 7 shows a side view of a light clip according to the first embodiment of the invention;

FIG. 8 shows a top view of a second embodiment of the invention;

FIG. 9 shows a back view of the second embodiment of the invention;

FIG. 10 shows a side view of the second embodiment of the invention;

FIG. 11 shows a lighting device including a rotatable top;

FIG. 12 shows a rotatable light source; and

FIGS. 13-14 show alternate shaped clips.

### DETAILED DESCRIPTION OF THE INVENTION

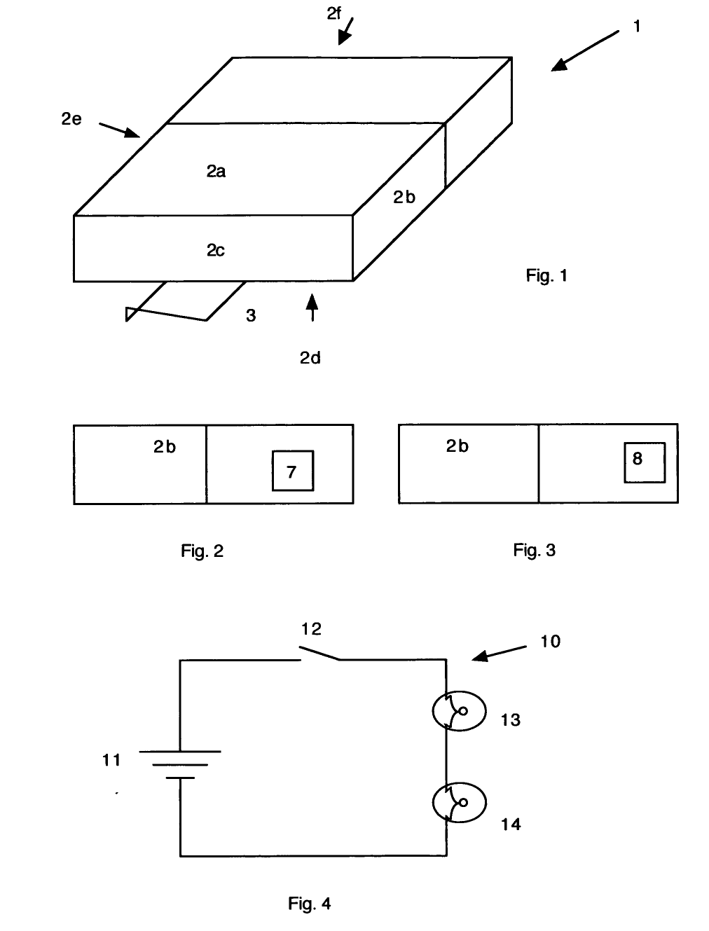

The first embodiment of the invention is shown in FIG. 1. FIG. 1 shows a light clip 1. Light clip 1 includes a base unit having a plurality of sides. FIG. 1 shows a rectangular base unit with top 2a, bottom 2d, and sides 2b, 2c, 2e, and 2f. FIG. 1 also shows clip member 3 of light clip 1, discussed in more detail below. FIG. 1 is designed to show a light clip including at least plural transparent sides. FIG. 2 shows side 2b of light clip 1. Side 2b includes a region 7 permitting access to a power supply, the power supply being either internal or external to the light clip. Typically light clip 1 has an internal power supply. However, in larger scale applications, an external power supply may be included. FIG. 3 shows side 2b including a region 8 having an external piece for turning light clip 1 on and off, which may be on the same side as access region 7.

Light clip 1 may be made from a rigid material, such a plastic. Light clip 1 may include a combination of plastic, clear and/or opaque, and/or glass for elements 2a, 2b, 2c, 2d, 2e, 2f and 3. It is desirable that light clip 1 also include a top surface 2a including transparent material and side surface(s) completing a perimeter region of the base unit of light clip 1 include a transparent material. An entire perimeter of the light clip may include transparent material. It is desirable that a range of approximately 90 degrees or 110 degrees of a perimeter region of the side(s) of the light clip to 270 degrees of a perimeter region of the side(s) of the light clip include clear, rigid plastic along with at least part of top surface 2a. It is possible that an entire side(s) region of the unit is opaque. Light clip 1 also includes a region for accessing a lighting circuit. For instance, top surface 2a may be partially or completely retractable or removable so that a light source and or other components of a lighting circuit may be accessible.

FIG. 4 shows elements of lighting circuit 10. Lighting circuit 10 includes power supply 11, switch 12 and lamps 13 and 14. Power supply 11 may be powered by a 3V power supply. Power supply 11 may be replaceable, rechargeable, or accessible from either a plug or adapter. Lighting circuit 10 may include additional components, such as at least one resistor, at least one capacitor, and at least one fuse, at least one transistor, at least one transformer, etc. depending on specifics of an application. Lamps provide a desired light intensity, although other light sources may be used. In addition, a switch is not necessary for the circuit However, switch 12 is desirable for conserving power.

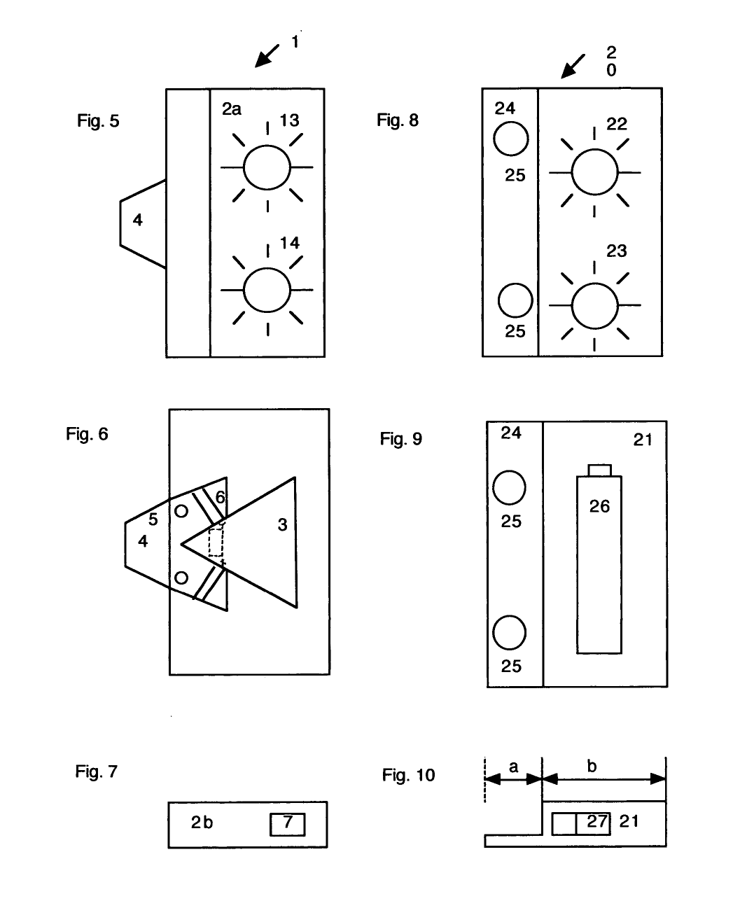

FIG. 5 shows a top view of light clip 1. At least part of an interior region of light clip 1 may be lined, with aluminum, for example, to increase reflection of light outward from the light clip. FIG. 6 shows a clip rotatably secure to bottom surface 2d. Light clip 1 includes a clip with a back member 4 secured to bottom surface 2d at apertures 5, a front member 3, and a fastening device 6 rotatably securing bottom surface 2d to front member 3. It is possible for back member 4 to be secure to bottom surface 2d by being integral with bottom surface 2d. FIG. 7 shows side 2b with a power supply accessible region 7. FIG. 7 shows side 2b including either an entire transparent material or an entire opaque material, for examples.

FIG. 8 shows a second embodiment of the invention. FIG. 8 shows a top view of a binder light 20 having base unit 21 and apertures 25. Base unit 21 includes a lighting circuit with components similar to the lighting circuit of the first embodiment. In this embodiment, there may be increased design aspects for a lighting circuit. Of course, lamps are desirable. FIG. 9 shows a bottom surface of binder light 20. Member 26 is allows access to an internal power supply of the binder light lighting circuit. FIG. 10 shows a side view of binder light 20 with switch member 27 accessible for turning binder mirror lighting circuit on and off. Typically, binder mirror 20 includes an internal power supply. Access area 26, however, may be designed to supply power to the binder light 20 from a plug or an adapter. FIG. 10 also shows regions “a” and “b” having different thickness. Region “a” having a different thickness than region “b” may be included in this embodiment for aesthetics.

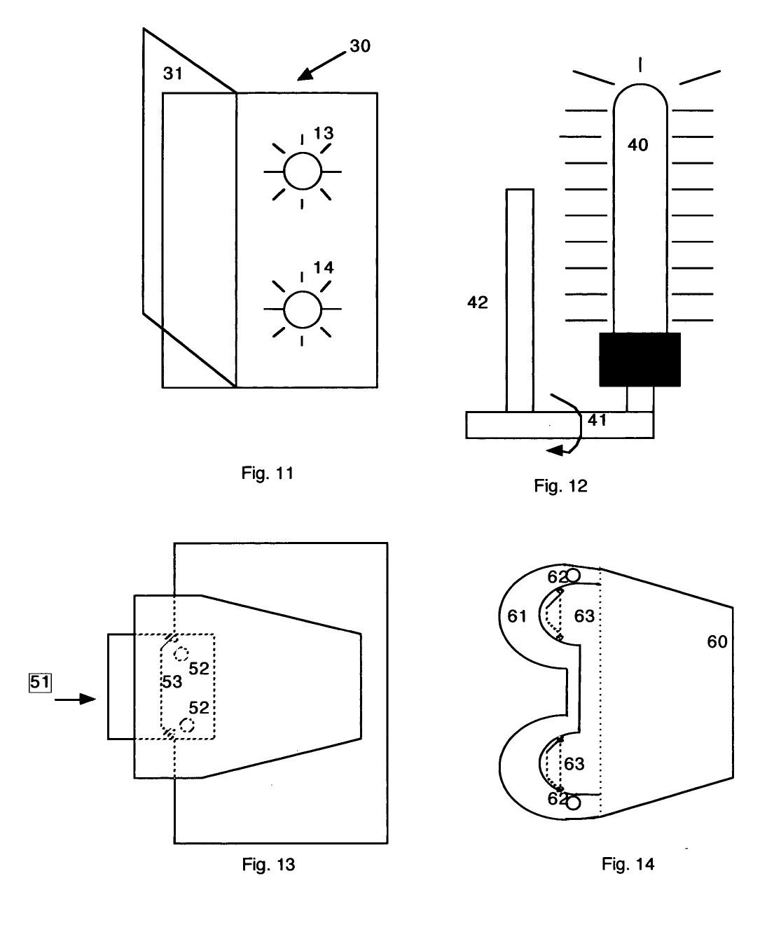

FIG. 11 shows a base of a unit 30 having a lid 31 that opens for accessing light sources 13 and 14. This feature may include an interior with a material for increased reflection of light. This design feature may be included in either embodiment. FIG. 12 shows a rotatable light source that may be used in either a light clip or a binder light. The rotatable light source includes light source 40, arm 41 supplying power thereto and lever 42 for increased rotation thereof. This feature may also be used in either embodiment

FIGS. 13 and 14 show alternate clips for securing to a base unit or bottom of a light clip. FIGS. 13 and 14 respectively show back members 51 and 61, apertures 52 and 62 for securing to a base of a clip, front members 50 and 60 rotatably secured to rear members 51 and 61 by fastening devices 53 and 63. An extension of front members 50 and 60 from a respective fastening device may be from a range of within the base unit to outward of the base unit. Either of front members 50 and 60 may include at least one portion being angled with respect to a respective back member of a respective unit in a rest position of the respective front member.

It is understood that the present disclosure is made for the purpose of illustration and various changes and modifications may be made without departing from the scope of the invention as set forth in the appended claims.

1.) A lighting device comprising:
a unit having a plurality of surfaces:
said surfaces including:
a top;
at least one side;
a base;
said top including a transparent material;
said at least one side having a perimeter encompassing 360 degrees;
an area encompassing a range of 90 degrees of said perimeter of said at least one side to 270 degrees of said perimeter of said at least one side including a transparent material;
a clip having:
a back member;
said back member being one of extending from and secured to said base of said unit;
a front member;
a fastening device;
said front member rotatably secured to said back member by said fastening device;
a lighting circuit positioned between said top of said unit and said base of said unit;
said lighting circuit having a plurality of components; and
at least one of said plurality of surfaces of said unit including at least one interior access region.

2.) A lighting device according to claim 1, further comprising at least one lamp.

3.) A lighting device according to claim 1, further comprising at least one replaceable lamp.

4.) A lighting device according to claim 1, further comprising two replaceable lamps.

5.) A lighting device according to claim 4, further comprising said lighting circuit including a 3V power supply.

6.) A lighting device according to claim 1, further comprising said at least one interior access region including a retractable portion.

7.) A lighting device according to claim 1, further comprising:
said base member of said unit having at least one edge region; and
said back member of said clip extending from a range of within said edge region to outward of said edge region of said base of said unit in a rest position of said back member.

8.) A lighting device according to claim 1, further comprising said lighting circuit including a replaceable power supply.

9.) A lighting device according to claim 1, further comprising said lighting circuit including a rechargeable power supply.

10.) A lighting device according to claim 1, further comprising said lighting circuit receiving power from a power supply through one of a plug and an adapter.

11.) A lighting device according to claim 1, further comprising:
said top having a length and a width;
said length of said top being greater than said width of said top;
said top including a transparent material; and
said transparent material extending across an entire length of said top.

12.) A lighting device according to claim 11, further comprising said transparent material including plastic.

13.) A lighting device according to claim 1, further comprising:
a lining encompassing at least part of an interior region of said unit for increasing reflection of light outward from said lighting circuit.

14.) A lighting device according to claim 13, further comprising said lining including aluminum.

15.) A lighting device according to claim 1, further comprising said transparent material including clear rigid plastic.

16.) A lighting device according to claim 1, further comprising a rotatable light source.

17.) A lighting device comprising:
a unit having a thickness and a base;
said base including:
a top;
a plurality of sides; and
a base member;
said unit having an edge region along at least one side of said plurality of sides exterior to said base of said unit, said edge region including at least one aperture;
a lighting circuit positioned between said top of said unit and said base member of said unit.

18.) A lighting device according to claim 17, further comprising said top of said unit including clear plastic.

19.) A lighting device according to claim 17, further comprising:
said top of said unit including clear plastic; and
at least another side of said plurality of sides including clear plastic.

20.) A lighting device according to claim 17 further comprising said unit including at least one interior access region.

21.) A lighting device according to claim 17, further comprising said lighting circuit including at least one lamp.

22.) A lighting device according to claim 17, further comprising said at least one lamp being replaceable.

23.) A lighting device according to claim 17, further comprising a 3 volt replaceable power supply.

24.) A lighting device according to claim 17, further comprising a replaceable power supply.

25.) A lighting device according to claim 17, further comprising a rechargeable power supply.

26.) A lighting device according to claim 17, further comprising:
said edge region having a first thickness;
said base having a second thickness; and
said first thickness being thinner than said second thickness.
